(19) United States
(12) Patent Application Publication
(10) Pub. No.: US 2008/0229033 A1
(43) Pub. Date: Sep. 18, 2008

(54) Method For Processing Data in a Memory Arrangement, Memory Arrangement and Computer System

(75) Inventors: Paul Wallner, Prien (DE); Peter Gregorius, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Munchen (DE)

(21) Appl. No.: 11/686,818

(22) Filed: Mar. 15, 2007

(51) Int. Cl. G06F 12/00

(52) U.S. Cl. 711/154

(57) ABSTRACT

A method processes data in a memory arrangement. The method includes receiving and transmitting the data from the memory arrangement in the form of data packets according to a predefined protocol. The method includes distributing each received data packet to at least two separate data packet processing units. Each data packet processing unit is coupled to a portion of memory cells of the memory arrangement. The method includes processing, at each data packet processing unit, parts of the received data packets that relate to the portion of the memory cells the data packet processing unit is coupled to. The method includes generating a data packet to be transmitted including setting up, with each data packet processing unit, a part of the data packet to be transmitted.

### BACKGROUND

Electronic data processing systems, such as computer systems typically include one or more memory arrangements for storing data. There are a variety of techniques for processing data in memory arrangements.

### SUMMARY

One embodiment provides a method of processing data in a memory arrangement. The method includes receiving and transmitting the data from the memory arrangement in the form of data packets according to a predefined protocol. The method includes distributing each received data packet to at least two separate data packet processing units. Each data packet processing unit is coupled to a portion of memory cells of the memory arrangement. The method includes processing, at each data packet processing unit, parts of the received data packets that relate to the portion of the memory cells the data packet processing unit is coupled to. The method includes generating a data packet to be transmitted including setting up, with each data packet processing unit, a part of the data packet to be transmitted.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic view of a memory arrangement.

FIGS. 2a-c are schematic block diagram representations of a data processing system.

FIG. 3 is a partial view of a memory arrangement according to an embodiment illustrating the arrangement of two data packet processing units of the memory arrangement.

FIG. 4 is a detailed schematic view of one embodiment of a synchronization unit of the memory arrangement illustrated in FIG. 3.

FIG. 5 is a partial view of a memory arrangement according to an embodiment illustrating the data output of read data using eight output ports.

FIG. 6 is a partial view of a memory arrangement according to an embodiment illustrating the output of read data using four output ports.

FIG. 7 is a partial view of a memory arrangement according to an embodiment illustrating the processing and repeating of received data.

FIG. 8 is a partial view of a memory arrangement according to an embodiment illustrating the generation and repeating of read data.

FIG. 9 is a timing diagram illustrating the synchronization of generated and repeated read data according to an embodiment.

FIG. 10 is a partial view of a memory arrangement according to an embodiment illustrating the processing of received data.

FIG. 11 is a partial view of a memory arrangement according to an embodiment illustrating the output of read data via eight output ports.

FIG. 12 is a partial view of a memory arrangement according to another embodiment illustrating the processing and repeating of received data via eight input and output ports.

FIG. 13 is a partial view of a memory arrangement according to an embodiment illustrating the generation and repeating of read data using four output ports.

FIG. 14 is a partial view of a memory arrangement according to an embodiment illustrating the processing of received data received via eight input ports.

FIG. 15 is a partial view of a memory arrangement according to an embodiment illustrating the generation and output of read data via eight output ports.

FIG. 16 is a partial view of a memory arrangement according to an embodiment.

FIG. 17 is a partial view of a memory arrangement according to an embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is also to be understood that, in the following description of the exemplary embodiments, any direct connection or coupling between functional blocks, devices, components, or other physical or functional units illustrated in the drawings or described herein could also be implemented by an indirect connection or coupling.

It is to be understood that the features of the various exemplary embodiments described herein may be combined with each other, unless specifically noted otherwise.

Embodiments of memory arrangements include memory arrangements used in data processing systems, for example in computer systems. In one embodiment, communication to and from a memory arrangement is accomplished by the transmission of data in the form of data packets according to a predefined protocol comprising read, write, address and command data packets. Nevertheless, embodiments may also be applied to memory arrangements having a conventional interface with parallel data, address and control lines, such as to memory arrangements having a high speed interface.

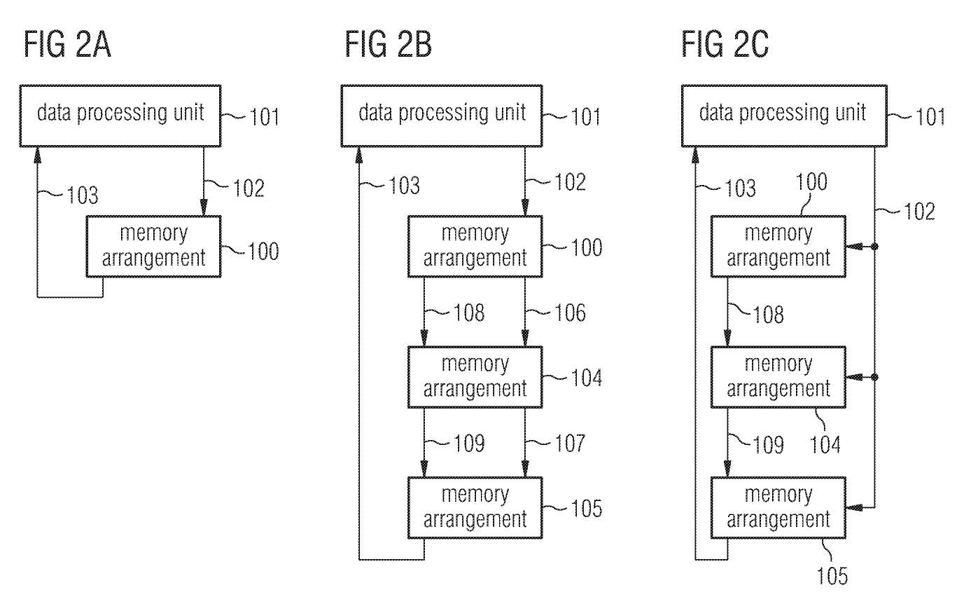

FIG. 2A illustrates an embodiment of a data processing system, for example a computer system, comprising a memory arrangement 100 and a data processing unit 101. The data processing unit 101 is connected to the memory arrangement 100 via a first connection 102 for transmitting address, command and write data packets from the data processing unit 101 to the memory arrangement 100, and via a second connection 103 for transmitting read data from the memory arrangement 100 to the data processing unit 101.

In one embodiment, when writing data from the data processing unit 101 to the memory arrangement 100, data packets containing address data, write data and command data for writing data are transmitted from the data processing unit 101 to the memory arrangement 100. The memory arrangement 100 receives the data packets and stores the write data into the addressed memory cells of the memory arrangement 100 after having decoded the data packets. When reading data from the memory arrangement 100, the data processing unit 101 transmits address data packets and a data packet containing the read command to the memory arrangement 100 and in response the memory arrangement 100, after having decoded the received data packets, retrieves the requested data from the memory cells of the memory arrangement 100 and transmits the read data packed in one or more data packets via the connection 103 from the memory arrangement 100 to the data processing unit 101.

FIG. 2B illustrates an embodiment for connecting more than one memory arrangement 100, 104, 105 to a data processing unit 101. According to this embodiment the memory arrangements 100, 104, 105 are arranged in a daisy chain, wherein the data packets containing command, address and write data transmitted from the data processing unit 101 are received via a connection 102 by the memory arrangement 100 and repeated by the memory arrangement 100 via the connection 106 to the memory arrangement 104 and repeated by the memory arrangement 104 via a connection 107 to the memory arrangement 105. The transmission of read data from the memory arrangements 100, 104, 105 to the data processing unit 101 is accomplished by connecting the memory arrangement 100 via connection 108 to the memory arrangement 104, connecting the memory arrangement 104 via a connection 109 to the memory arrangement 105 and connecting the memory arrangement 105 via connection 103 to the data processing unit 101.

In this embodiment, when writing data from the data processing unit 101 to any of the memory arrangements 100, 104, 105, command, address and write data packets are transmitted from the data processing unit 101 to each of the memory arrangements 100, 104 and 105 either directly via connection 102 or indirectly via connections 106 and 107 repeated from memory arrangements 100 and 104. The memory arrangement that contains the addressed memory cell stores the transmitted write data in the respective memory cell. When reading data from one of the memory arrangements 100, 104, 105 to the data processing unit 101, the data processing unit 101 transmits command and address data packets to each of the memory arrangements as described above, and the memory arrangement that contains the addressed memory cell retrieves the data from its memory cell and transmits the read data packed in a data packet to the data processing unit 101. If the read data packet is generated at memory arrangement 105, the read data packet can be transmitted directly via connection 103 to the data processing unit 101. If the read data packet is generated at memory arrangement 104, memory arrangement 104 transmits the read data packet via connection 109 to the memory arrangement 105, and memory arrangement 105 in turn repeats the received read data packet via connection 103 to the data processing unit 101. In case of high data rates having frequencies of (e.g., one GHz or above) the repeating may require an additional re-aligning for avoiding the occurrence of phase offsets. In case the read data packet is generated at memory arrangement 100, memory arrangement 100 transmits the read data packet via connection 108 to memory arrangement 104, which in turn repeats the read data packet via connection 109 to memory arrangement 105, which in turn repeats the read data packet via connection 103 to the data processing unit 101.

FIG. 2C illustrates an embodiment for connecting more than one memory arrangement 100, 104, 105 with a data processing unit 101. In this embodiment the memory arrangements 100, 104, 105 are each directly connected via a point-to-multipoint or a fly-by connection 102 for providing command, address and write data packets from the data processing unit 101 to the memory arrangements 100, 104, 105, and connected via daisy chain connections 108, 109, 103 for transmitting read data packets in a daisy chain to the data processing unit 101 as described in connection with FIG. 2B.

In this embodiment, when writing data from the data processing unit 101 to the memory arrangements 100, 104, 105, the command, address and write data packets are transmitted via connection 102 to each of the memory arrangements 100, 104, 105. The memory arrangement containing the addressed memory cell stores the received write data into its memory cell. When reading data from the memory arrangements 100, 104, 105 to the data processing unit 101, the data processing unit 101 transmits command and address data packets via the connection 102 to each of the memory arrangements 100, 104, 105. The memory arrangement containing the addressed memory cell in turn retrieves the addressed read data and transmits a corresponding read data packet as described above in conjunction with FIG. 2B via the daisy chain connection 108, 109 and 103 to the data processing unit 101.

In the following, the connections for transmitting the command, address and write data packets 100, 106, 107 and the connections for transmitting the read data packets 108, 109, 103 are described in more detail. The connections, ports, packets and components concerning the command, address and write data packet transmission and processing will be called eCA (embedded command and address) connections, ports, packets and components in the following. The connections, ports, packets and components concerning the transmission and processing of read data packets are called DQ connections, ports, packets and components in the following.

An eCA data packet may comprise 54 bits. The eCA connections 102, 106 and 107 may comprise each six data lines transmitting each nine bits serially per eCA data packet. As an alternative, an eCA data packet may comprise 64 bits, and each eCA connection 102, 106 and 107 may then comprise eight data lines transmitting each eight bits serially per data packet.

In one embodiment, a DQ data packet may comprise 72 bits, wherein each DQ data packet is transmitted via eight data lines of a DQ connection 108, 109 or 103 transmitting each nine bits serially per DQ data packet. In another embodiment, a DQ data packet may comprise 36 bits transmitted via four DQ data lines, wherein each DQ data line transmits nine bits serially per DQ data packet.

In general, the data lines of the eCA as well as the DQ connections may comprise each a two wire connection transmitting the data signals as a differential data signal.

In general, a memory arrangement embodiments can be designed to provide an architecture and interfaces to be used in the configuration illustrated in FIG. 2A or in the configuration illustrated in FIG. 2B or in the configuration illustrated in FIG. 2C. In one embodiment, a memory arrangement can be designed to be configurable to be usable in any of the configurations illustrated in FIGS. 2A-2C depending on an initial configuration of the memory arrangement. Furthermore any combination of the architectures illustrated in FIGS. 2A to 2C may be implemented within one system, for example, if the data processing unit provides more than one interface to the memory arrangement, any combination of the architectures illustrated in FIGS. 2A to 2C may be implemented in parallel.

For an application, the memory arrangement is used in, for example, a computer system in a server application, a consumer product like an X-Box, or a mobile application, each of the different architectures provides special advantages in relation to, for example, space on a circuit board, wiring complexity on a circuit board, number of memory arrangements to be used, memory size, data access latency, or data transmission rate. For reducing the number of lines for connecting the memory arrangements 100, 104 and 105 illustrated in FIG. 2B, the DQ connection may comprise only four data lines, whereas the DQ connection 103 illustrated in FIG. 2A may comprise eight data lines resulting in a much higher transmission rate with reduced latency. In memory arrangements that are configurable to support the connection architectures illustrated in FIGS. 2A and 2B, the DQ connection may comprise a different number of data lines depending on the configuration of the memory arrangement. If the memory arrangement is configured to be used in an architecture, such as illustrated in FIG. 2A, the memory arrangement 100 may comprise six eCA data lines and eight DQ data lines, whereas the same memory arrangement configured to be used in an architecture, such as illustrated in FIG. 2B, may comprise six eCA data lines receiving eCA packets, six data lines for repeating eCA packets, four DQ data lines for receiving DQ data packets and four data lines for transmitting DQ data packets, wherein the eight DQ lines for architecture of FIG. 2A may use the same physical connectors as the four plus four DQ data lines of the architecture illustrated in FIG. 2B.

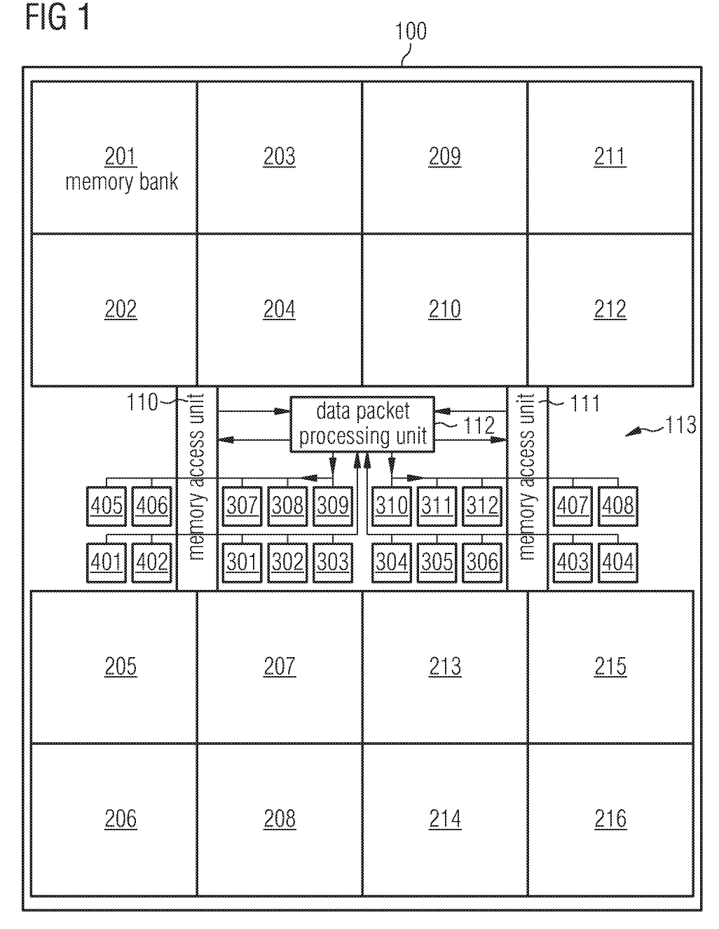

FIG. 1 illustrates an embodiment of the memory arrangement 100, comprising 16 memory banks 201-216, two memory access units 110, 111, a data packet processing unit 112, eCA data line ports 301-312, and DQ data line ports 401-408. The memory banks 201-216 comprise each a number of memory cells for storing and retrieving data. The memory cells of the memory banks 201-208 are accessible via the memory access unit 110, whereas the memory cells of the memory bank 209-216 are accessible via the memory access unit 111. The number of memory banks is exemplary only and may for example comprise only two, four or eight memory banks instead of 16 or even more than 16.

The arrangement of the memory banks 210-216 and the memory access units 110 and 111 in the way illustrated in the embodiment of FIG. 1 with eight upper memory banks 201-204, 209-212 spaced apart from eight lower memory banks 205-208, 213-216 with the memory access units 110, 111 disposed between the upper and lower memory banks promote achieving a homogenous timing behavior to all memory cells of the memory banks 201-216. The space between the upper and lower memory banks comprises not only the memory access units 110 and 111, but also the data packet processing unit 112 and the eCA ports 301-312 and the DQ ports 401-408. In the following the space between the upper and lower memory banks is called spine 113.

The memory arrangement 100 of FIG. 1 is designed to be used for example as the memory arrangements 100, 104 or 105 of FIG. 2B or FIG. 2C. The eCA ports 301-306 receive eCA data packets received from the processing unit 101 or from a preceding memory arrangement in a daisy chain arrangement and direct the data of the received eCA data packet to the data packet processing unit 112. The data packet processing unit 112 outputs the received data of the eCA data packets to the eCA data output ports 307-312 for repeating the eCA data to a succeeding memory arrangement in a daisy chain architecture. Additionally, the data packet processing unit 112 decodes the received eCA data packet and performs the action requested by the eCA data packet according to a predefined protocol. This comprises, for example, the storing of write data or the retrieving of read data. In one embodiment, repeating the eCA data packets may be accomplished by directly forwarding the eCA data packets received from the eCA ports 301-306 to the eCA data output ports 307-312. An additional logic between the eCA ports 301-306 and the eCA data output ports 307-312 may be employed to align the phase of the repeated signals.

In the case of a write data request the data packet processing unit 112 forwards these write data together with the received addressing data to the memory access units 110 and 111, which in turn write the write data into the corresponding memory cells of the memory banks 201-216.

In the case of a data read request the data packet processing unit 112 forwards the read request and the addressing data to the memory access units 110 and 111, which in turn retrieve the requested data from the memory cells of memory banks 201-216 and returns the retrieved read data to the data packet processing unit 112. The requested read data may be retrieved either via one of the memory access units 110 or 111 and then returned to the data packet processing unit 112, or one part of the requested read data may be retrieved via memory access unit 110 and the remaining part of the requested read data may be retrieved via memory access unit 111 and then both parts may be returned in combination to the data packet processing unit 112. The data packet processing unit 112 packages the read data into DQ data packets and transmits the DQ data packets via the DQ output ports 405-408 to the data processing unit 101 or a succeeding memory arrangement. Additionally, the data packet processing unit 112 repeats or forwards each DQ data packet received from a preceding memory arrangement via the DQ input ports 401-404 to the DQ output ports 405-408. In one embodiment, repeating the DQ data packets may be accomplished by directly forwarding the DQ data packets received from the DQ input ports 401-404 to the DQ output ports 405-408. An additional logic between the DQ input ports 401-404 and the DQ output ports 405-408 may be necessary to align the phase of the repeated signals.

In one embodiment, the die size of the memory arrangement 100 is mainly determined by the area size necessary for the memory banks 201-216 and the area size of the spine 113. The die size of the memory arrangement 100 can be reduced by minimizing the height of the spine 113, wherein the height of the spine 113 means the distance between the upper memory banks 201-204, 209-212 and the lower memory banks 205-208, 213-216. Due to timing restrictions a lot of functions, for example the data packet processing unit 112, clock and synchronization units (not illustrated), and input and output ports, for example eCA and DQ ports, may be arranged in a central area of the spine 113, which means in the area between the memory access units 110 and 111. Placing these functionalities in the center of the spine 113 employs significant space in the center area of the spine 113, whereas the outer areas of the spine (i.e., the areas left of memory access unit 110 and right of memory access unit 111 in FIG. 1), remain unused. This results in a spine 113 with a relatively large height.

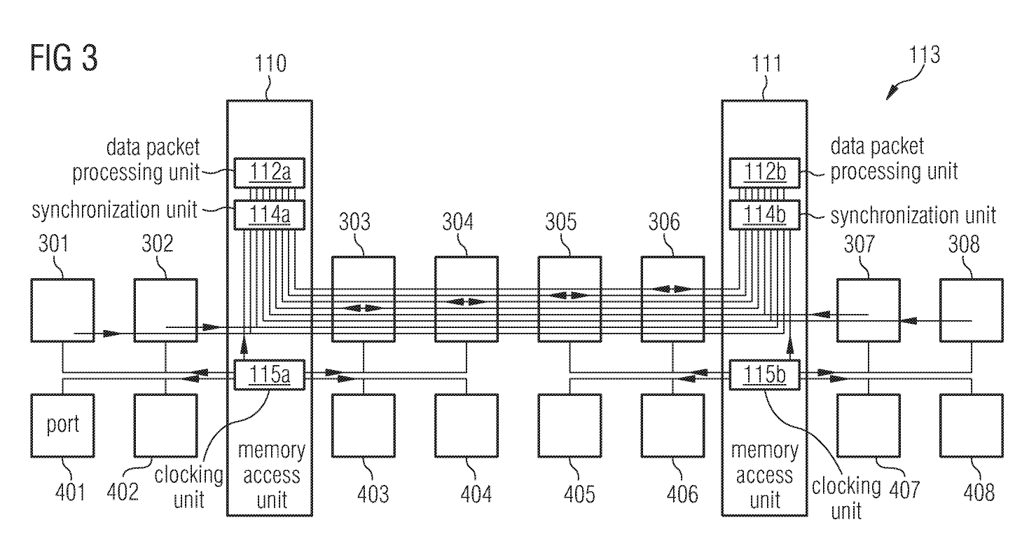

Therefore, FIG. 3 illustrates an embodiment of a spine 113 of a memory arrangement, where two data packet processing units 112a, 112b are arranged in the memory access units 110 and 111, respectively. As the data packet processing units can also be arranged nearby the memory access units, whenever an arrangement within or in the memory access units is stated in this description, this implies also an arrangement nearby the memory access units. The spine 113 further comprises eight eCA input ports 301-308 for receiving eCA data packets and eight DQ output ports 401-408 for transmitting DQ data packets. As the memory arrangement containing the spine 113 does not provide the repeater functionality for arranging several memory arrangements in a daisy chain, the memory arrangement containing this spine 113 may be used in a data processing arrangement as illustrated in FIG. 2A.

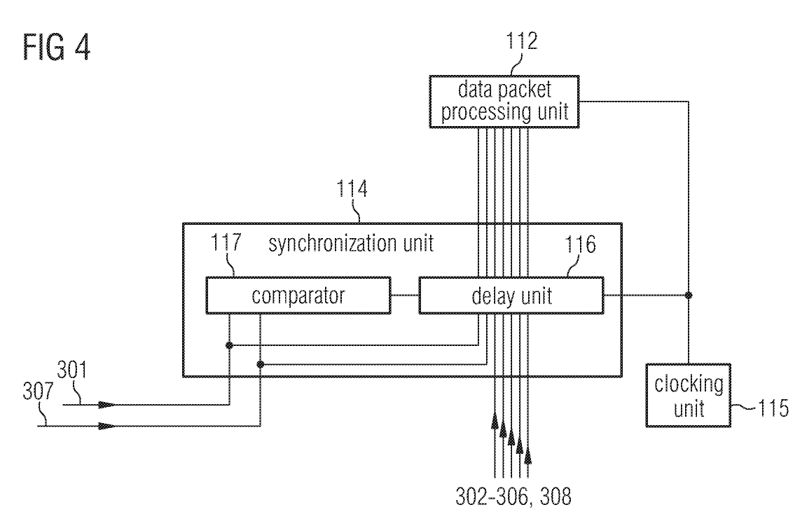

The spine 113 contains additionally in the memory access units 110 and 111 synchronization units 114a and 114b and clocking units 115a and 115b, respectively. As illustrated in FIG. 3, an eCA data packet received by the eCA input ports 301-308 is directed to both data packet processing units 112a and 112b. As the distance between the nearest eCA input port and the farthest eCA input port relative to one data packet processing unit 112a, 112b becomes rather large (e.g., propagation over the distance may, for example, take about 1 ns which is significant when transmitting frequencies in the GHz range) in the arrangement illustrated in FIG. 3, a synchronization unit 114a, 114b is arranged between the eCA input ports 301-308 and the data packet processing units 112a and 112b, respectively. The received eCA data is synchronized by the synchronization units 114a and 114b to separate clocks derived from clocking units 115a and 115b, respectively. Details of this synchronization is described later in conjunction with FIG. 4.

In one embodiment, the synchronized received eCA data is then output from the synchronization units 114a and 114b to the data packet processing units 112a and 112b, respectively. Data packet processing unit 112a, which is associated with memory access unit 110, decodes the received eCA data packet and performs the requested actions, for example writing or retrieving data, related to the memory cells of the memory banks 201-208 to which the memory access unit 110 is connected. Data packet processing unit 112b also decodes the received eCA data packets and performs the requested actions concerning the memory cells contained in memory banks 209-216 connected to the memory access unit 111.

As write data is distributed to each of the data packet processing units 112a, 112b, each data packet processing unit can process and store the write data assigned to the memory cells connected to the respective memory access unit 110 and 111, respectively. When performing a read request, the data packet processing units 112a and 112b retrieve the requested read data from the memory cells of the memory banks connected to the memory access units 110, 111, respectively, and output the respective data packaged into DQ data packets via the DQ output ports 401-408.

In an protocol definition the DQ data packets can be set up in such a way that read data retrieved by memory access unit 110 are output via DQ output ports 401-404, and read data retrieved by memory access unit 111 are output via DQ output ports 405-408, as illustrated in FIG. 3.

By placing two data packet processing units 112a, 112b outside the center of the spine 113, the height of the spine can be reduced and therefore the total amount of used die size for a memory arrangement can be reduced. Furthermore two clock trees, one for each data packet processing unit 112a, 112b may be utilized, wherein each clock tree has a reduced clock tree length, which can reduce the used chip area amount, the power consumption, and the number of clock buffers, resulting in a simplified timing architecture.

FIG. 4 illustrates an embodiment of a detailed view of a synchronization unit 114, which may be used as synchronization unit 114a or 114b of FIG. 3, comprising a comparator 117 and a synchronization and delay unit 116. The comparator 117 determines the offset between the data coming from the furthest input port, for example eCA input port 301 in the case of synchronization unit 114b, with the data coming from the nearest input port, for example eCA input port 307 in the case of synchronization unit 114b, and controls the delay and synchronization unit 116 in such a way that all the data lines have the same phase and are aligned to the clock of clocking unit 115 before they are output to the data packet processing unit 112.

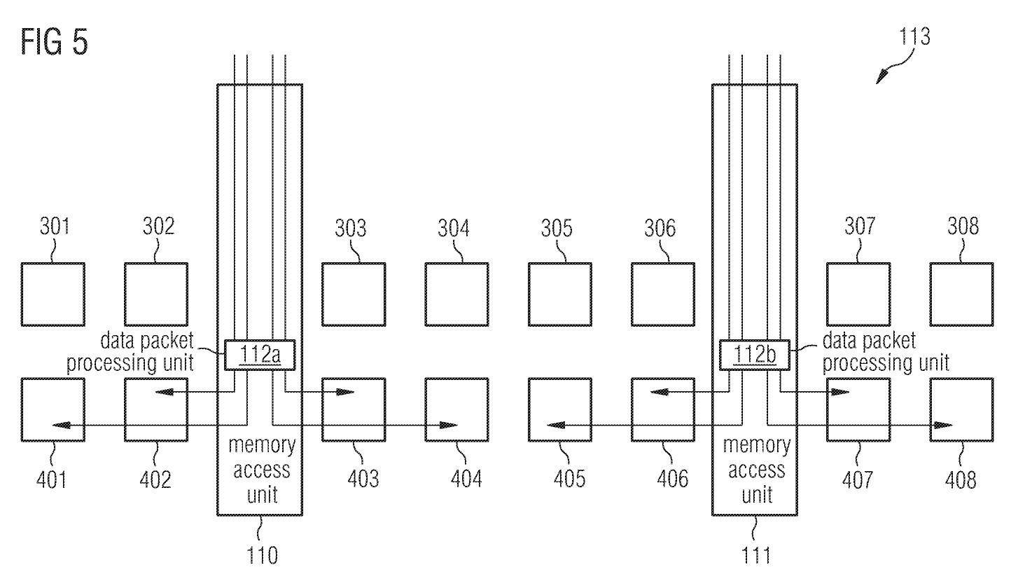

FIG. 5 illustrates the data flow of the read data within spine 113 of the embodiment of FIG. 3. The read data pass from the memory banks into the memory access units 110 and 111 and are packaged by the data packet processing units 112a and 112b, respectively, before the read data are output via the DQ output ports 401-408.

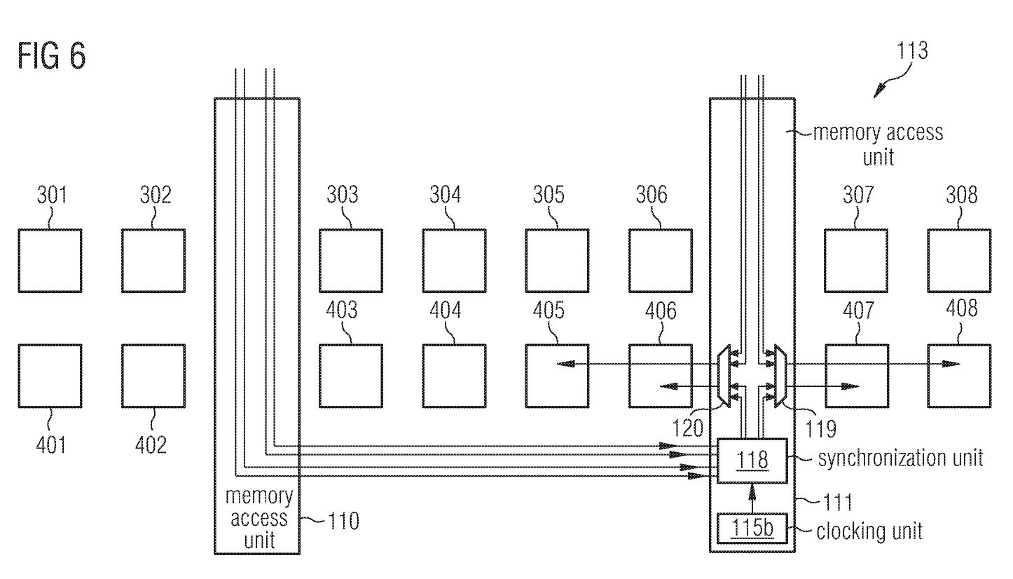

A case where a memory arrangement containing a spine 113 as illustrated in FIG. 3 is used in a configuration where only four DQ lines for transmitting DQ data packets shall be used, is illustrated in FIG. 6 according to one embodiment. In this case, read data coming from memory banks 201-208 via memory access unit 110 are forwarded from memory access unit 110 to memory access unit 111 as illustrated in FIG. 6. The read data from memory access unit 110 are synchronized with a synchronization unit 118 of the memory access unit 111 to the clock of the clocking unit 115b and then forwarded to multiplexers 120 and 119. The multiplexers 120, 119 are used to output either the synchronized read data coming from the memory access unit 110 or the read data coming from memory banks 209-216 via the memory access unit 111 to DQ output ports 405-408. The multiplexers 120 and 119 are controlled by the data packet processing unit 112b, which is not illustrated in FIG. 6. As an alternative, synchronization unit 118, clocking unit 115b, and multiplexers 120 and 119 may be arranged in memory access unit 110 and the read data may be output to DQ output ports 401-404.

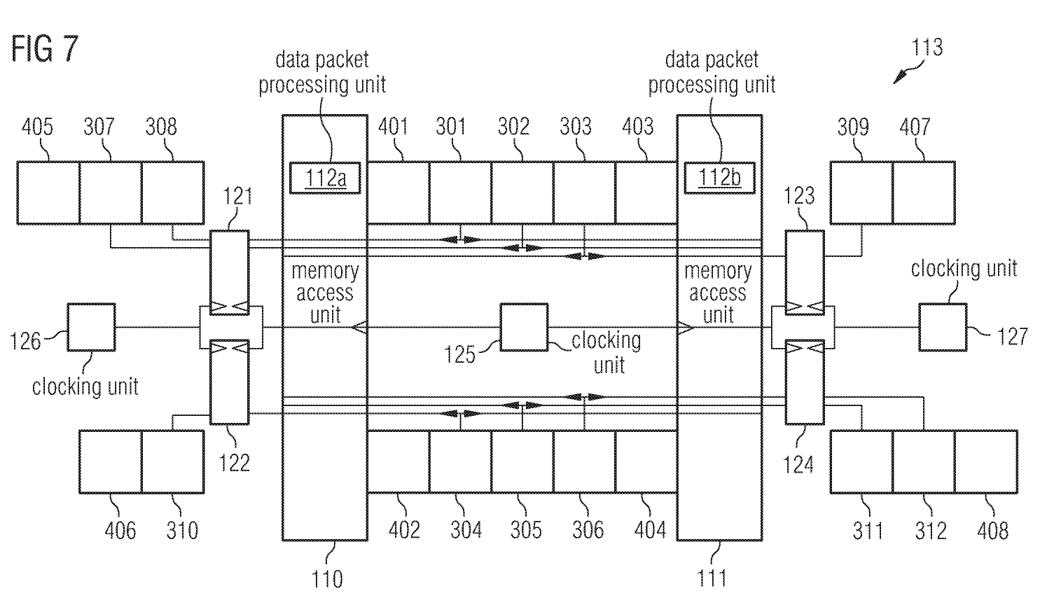

FIG. 7 illustrates an embodiment of a spine 113 of a memory arrangement, comprising two memory access units 110 and 111, containing data packet processing units 112a and 112b, respectively, eCA input ports 301-306, eCA output ports 307-312, DQ input ports 401-404 and DQ output ports 405-408.

In this embodiment, the eCA and DQ input ports 301-306 and 401-404 are arranged in an area between the memory access units 110 and 111, whereas a first portion of the eCA and DQ output ports 307, 308, 310, 405, 406 are arranged in an area extending from memory access unit 110 in a direction opposite to memory access unit 111, and a second portion of eCA and DQ output ports 309, 311, 312, 407, 408 are arranged in an area extending from the memory access unit 111 in a direction opposite to memory access unit 110. Furthermore, a receive clock unit 125 is arranged between the memory access units 110 and 111 as illustrated in FIG. 7.

By arranging the input ports in such a centralized way within the spine 113, both data packet processing units can be supplied with the same receive clock from the receive clock unit 125 and no additional synchronization of data coming from the input ports has to be performed. The processing of the received eCA data packets can be performed as described in connection with FIG. 3. Furthermore, the eCA data packets can be repeated to be output via eCA data packet output ports 307-312, as this is employed for using the memory arrangement in an architecture as illustrated in FIG. 2B.

Due to the different lengths of the connections between the eCA input ports 301-306 and the eCA output ports 307-312, the data to be repeatedly output on the eCA output ports 307-312 has to be resynchronized before being output. This may be accomplished by FIFO stages 121-124 or the like for connecting two clock domains, the receive clock and the output clock, even if the phase offset may be larger than one clock cycle. Into these FIFO stages 121-124 the eCA data coming from the eCA input ports 301-306 are input synchronously to the receive clock of receive clock unit 125 and output to the eCA output ports 307, 308, 310 and 309, 311, 312, respectively, synchronously to the output clocks delivered from output clock units 126 and 127, respectively.

Again, the spine according to the embodiment illustrated in FIG. 7 can be made rather small, as the data packet processing units 112a, 112b are arranged outside the centre of the spine 113. Additionally, received eCA data is processed with one receive clock of the receive clock unit 125 only, providing a synchronous processing of data packet processing units 112a and 112b. The output of eCA data is synchronized to two output clocks of output clock units 126 and 127, respectively, which enables the whole spine to be designed with relatively short clocking trees (e.g., one receive clock and two transmit clocks) which simplifies the clock distribution and reduces the power consumption due to the reduced clock tree routing as the clock distribution of a clock within the range of one GHz or more can be a significant adder to the overall power consumption.

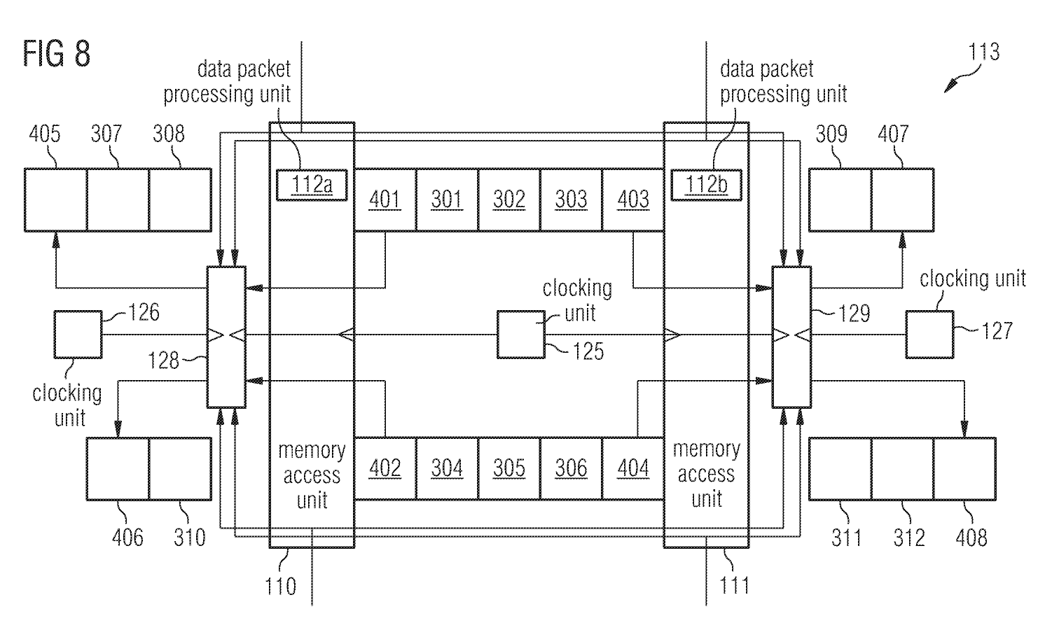

FIG. 8 illustrates one embodiment of the data flow of the DQ data within the spine 113 of FIG. 7. Again, the memory arrangement containing the spine 113 of the FIG. 8 embodiment is designed to be used in a memory architecture as illustrated in FIG. 2b, that means that DQ data can be forwarded by the memory arrangement arranged in a daisy chain arrangement. Therefore, the spine 113 provides DQ input ports 401-404 receiving DQ data packets to be forwarded to another memory arrangement via the DQ output ports 405-408. Additionally, when retrieving data from the memory banks of the memory arrangement itself, DQ data packets are output at the DQ output ports 405-408. To accomplish this functionality, spine 113 provides two multiplexing FIFOs 128 and 129, which receive on the one hand data from the DQ input ports 401, 402 and 403, 404, respectively, that are clocked into the FIFOs 128, 129 synchronously to the receive clock of the receive clock unit 125. On the other hand, the multiplexing FIFOs 128, 129 are connected with the memory banks via the memory access units 110 and 111, respectively. The multiplexing FIFOs 128 and 129 are controlled by the data packet processing units 112a and 112b, respectively, to either store DQ data received from the DQ input ports 401, 402 and 403, 404, respectively, or from the memory access units 110 and 111, respectively. The DQ data stored in the multiplexing FIFOs 128, 129 are output via DQ output ports 405, 406 and 407, 408, respectively, synchronously to output clocks from output clock units 126 and 127, respectively.

Such an arrangement provides a synchronous processing of the data packet processing units 112a and 112b, as they are both provided with the same receive clock of receive clock unit 125, and short clocking trees supplied by the receive clock unit 125 and the output clock units 126 and 127.

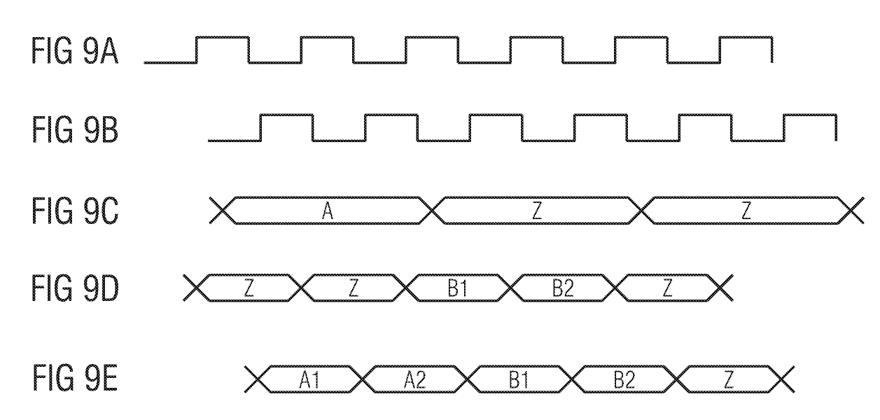

FIG. 9 illustrates a timing diagram for signals of the spine 113 of FIG. 8 according to one embodiment. FIG. 9a illustrates the signal of the receive clock of the receive clock unit 125, FIG. 9b illustrates the output clock of the output clock unit 126, 127, FIG. 9c illustrates the data coming from the memory banks via the memory access units 110, 111 to the FIFO multiplexers 128, 129, FIG. 9d illustrates the received DQ data passed by the DQ input ports 401-404 to the multiplexing FIFOs 128, 129, and FIG. 9e illustrates the DQ data output from the multiplexing FIFOs 128, 129 to the DQ output ports 405-408.

In this embodiment, with every rising edge of the receive clock illustrated in FIG. 9a, a DQ packet is received via DQ input ports 401-404. Accordingly, with every rising edge of transmit clock, illustrated in FIG. 9b, a DQ packet is transmitted via DQ output ports 405-408. A Z in a DQ packet in FIGS. 9d and 9e means that no valid data is contained in said DQ packet. Assuming that upon one read request of an eCA packet two DQ data packets have to be output to answer this read request, the read data indicated as “A” in FIG. 9c retrieved from the memory banks and provided by the memory access units 110, 111 to the multiplexing FIFOs 128, 129 is output with the next two rising edges of the output clock illustrated in FIG. 9b as the two data packets “A1” and “A2” illustrated in FIG. 9e. During the output of data packet “A2” a DQ data packet “B1” is received via the DQ input ports 401-404 as illustrated in FIG. 9d synchronously to the receive clock illustrated in FIG. 9a. Accordingly, this data packet “B1” is then output via the DQ output ports 405-408 synchronously with the next rising edge of the transmit clock after DQ data packet “A2” has been output, as illustrated in FIGS. 9b and 9e. In a similar way, the next DQ data packet “B2” received via DQ input ports 401-404 is repeated to the DQ output ports 405-408 as illustrated in FIGS. 9d and 9e. In one embodiment, a data processing unit takes care that there is no read request to a memory and concurrently data have to be repeated.

As illustrated in the example above, the multiplexing FIFOs 128, 129 provide a synchronization of DQ packets received via DQ input ports 401-404 to be repeated to DQ output ports 405-408 together with read data retrieved from the memory banks via the memory access units 110, 111 and enabling thus the use of three clocking areas, the receive clock provided by receive clock unit 125 and the two transmit clocks provided by the transmit clock units 126 and 127.

The memory arrangement embodiments containing the spine 113 described in connection with FIGS. 7-9 may also be used in an architecture as illustrated in FIG. 2a (i.e., without repeating the eCA in DQ data packets). As explained above, this may be accomplished by using a memory arrangement dedicated to be used in such an architecture only, or a memory arrangement which is configurable to be used in one of the architectures after being configured in an initializing setup procedure.

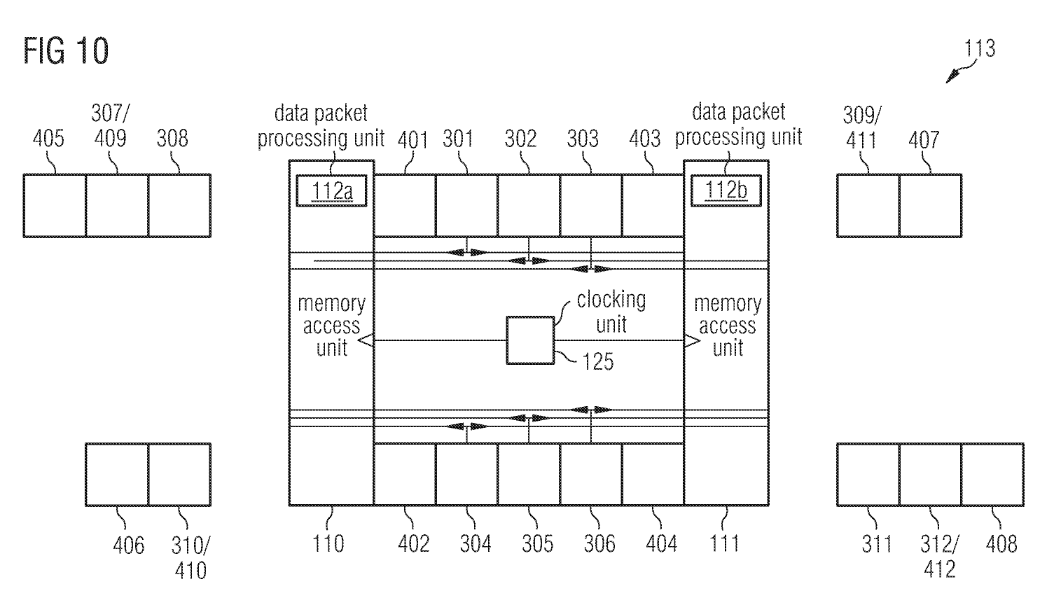

FIG. 10 illustrates one embodiment of a data flow within the spine 113 for a memory arrangement used in the architecture illustrated in FIG. 2a. The eCA input ports 301-306 are arranged in the same way as described in FIG. 7, but eCA data is only received by the eCA data input ports 301-306 and then forwarded to the data packet processing units 112a, 112b contained in memory access units 110 and 111, respectively, but not repeated to eCA output ports, as illustrated in FIG. 7.

Therefore, eCA output ports 307-312 are not needed for outputting repeated eCA data packets. Instead, four of the six not needed eCA outputs 307-312 may be used for additionally outputting DQ data packets, and therefore in the embodiment of FIG. 10 the output ports 307, 309, 310 and 312 are additionally referenced as DQ output ports 409-412. The processing of the eCA data packets is the same as described in conjunction with FIG. 7 besides repeating the eCA data packets.

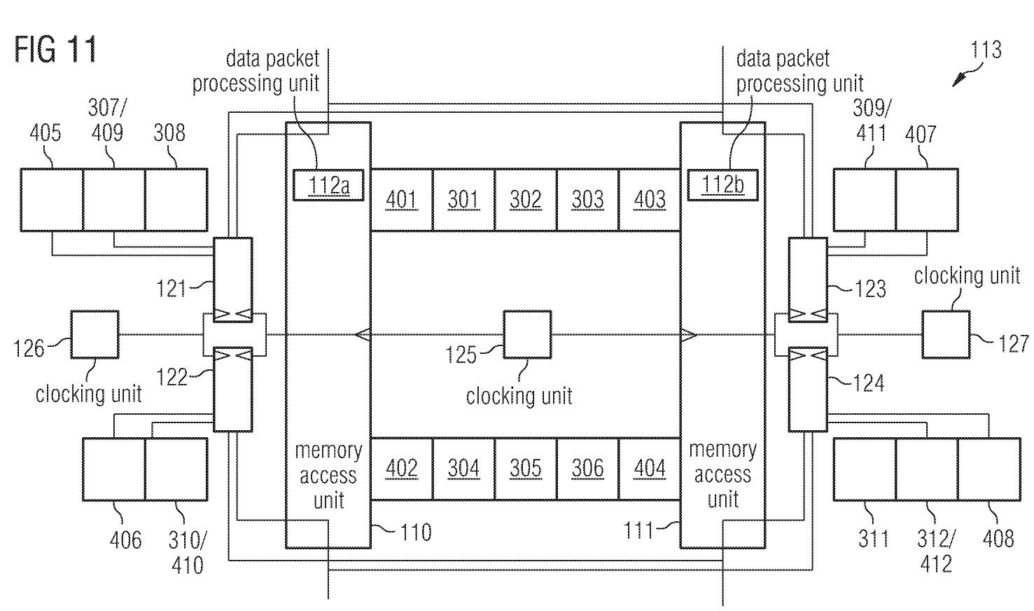

FIG. 11 illustrates one embodiment of a data flow of the DQ data in the spine 113 of the memory arrangement containing the spine 113 of FIG. 10. As the memory arrangement is used in a data processing architecture as illustrated in FIG. 2A where no repeating of DQ data packets is needed, the DQ input ports 401-404 are not used in the configuration of the spine 113 of FIG. 11. As described above, the not needed eCA output ports 307, 309, 310, and 312 may be used for additionally outputting DQ data and are therefore referenced as DQ output ports 409-412 in FIG. 11. The output of DQ data packets is then accomplished by outputting read data received from the memory banks via memory access units 110, 111, synchronized via FIFOs 121-124 to the output clocks of the output clock units 126 and 127 and then output to the DQ output ports 405-412.

Using the memory arrangement with the spine 113 configured as illustrated in FIGS. 10 and 11 to be used in a data processing architecture illustrated in FIG. 2a can provide an increased data rate transmission for DQ data packets without increasing the number of output ports of the memory arrangement. Therefore, embodiments the memory arrangement provide versatility usable in data processing architectures employing either large amounts of memory, for example architectures illustrated in FIG. 2b or 2c, or employing high speed data transmissions, as illustrated in FIG. 2a.

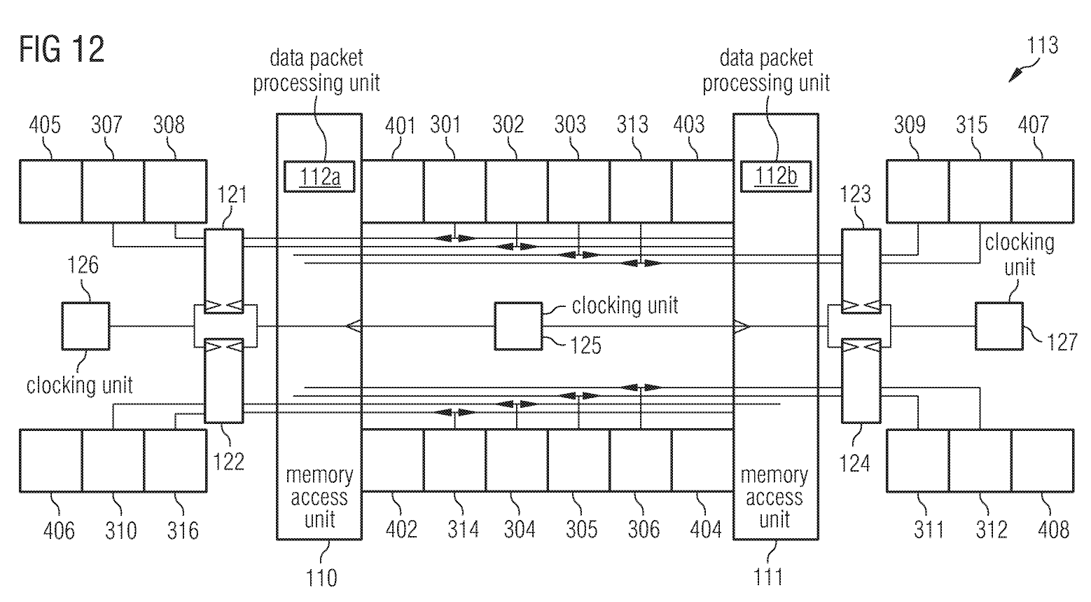

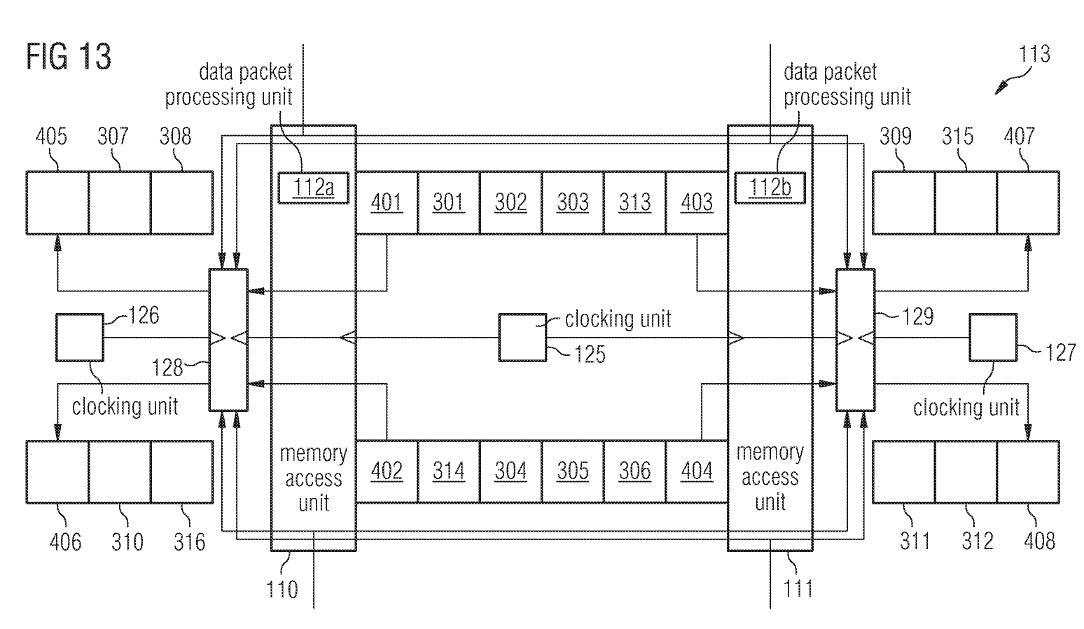

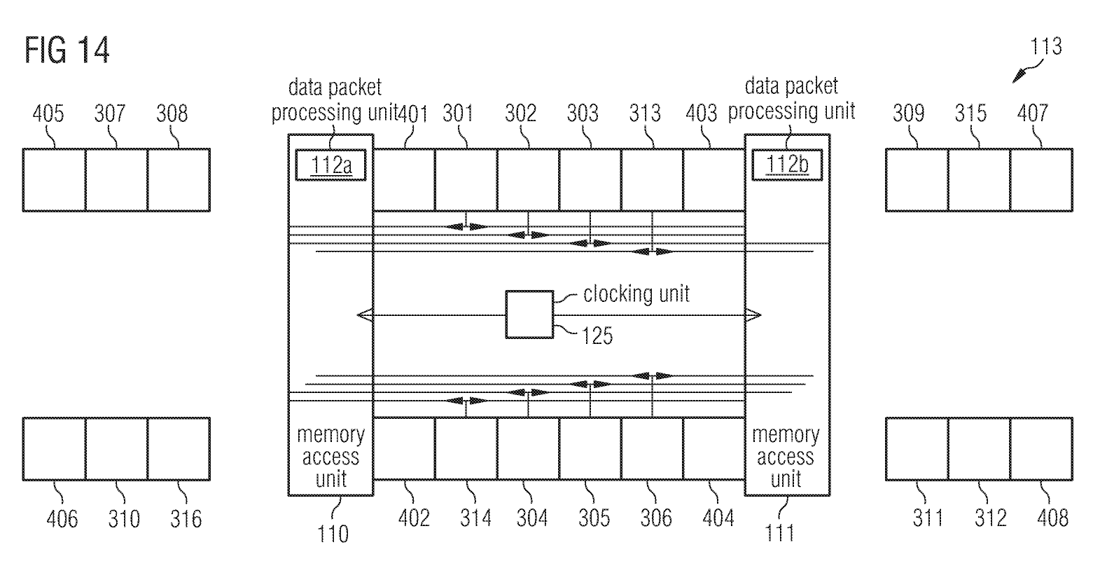

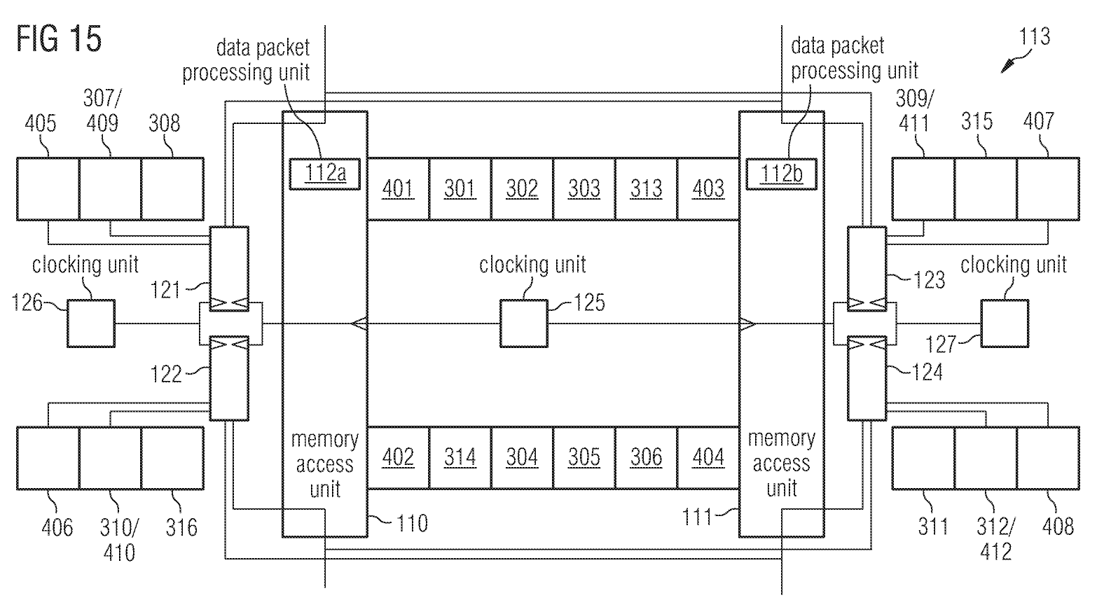

An embodiment of the spine 113 of the memory arrangement is illustrated in FIGS. 12-15. One difference between the embodiment illustrated in FIGS. 12-15 compared with the embodiment illustrated in FIGS. 7-11 is that for transmitting eCA data packets instead of six eCA input and output ports now eight eCA data input and output ports are used. Therefore, the spine 113 of FIGS. 12-15 additionally comprises eCA input ports 313 and 314 and eCA output ports 315 and 316. The remaining structure and the data flow of FIGS. 12, 13, 14 and 15 is the same as described in conjunction with FIGS. 7, 8, 10 and 11, respectively.

An eCA data packet of this embodiment may comprise 64 bits that are transmitted via the eight eCA data ports, wherein each port transmits eight bits per data packet serially. Thus, not only the number of bits per data packet is increased compared with the nine by six bits of the previous embodiment, but also the timing becomes easier, as the clock rate of the packets is ⅛ of the data bit rate of each eCA data port.

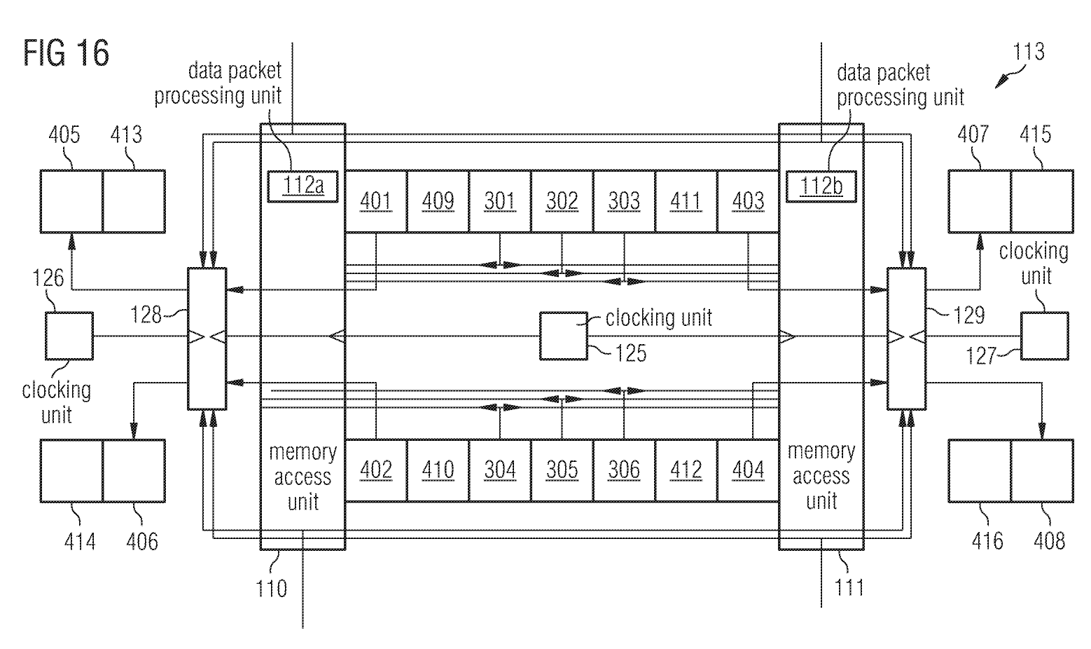

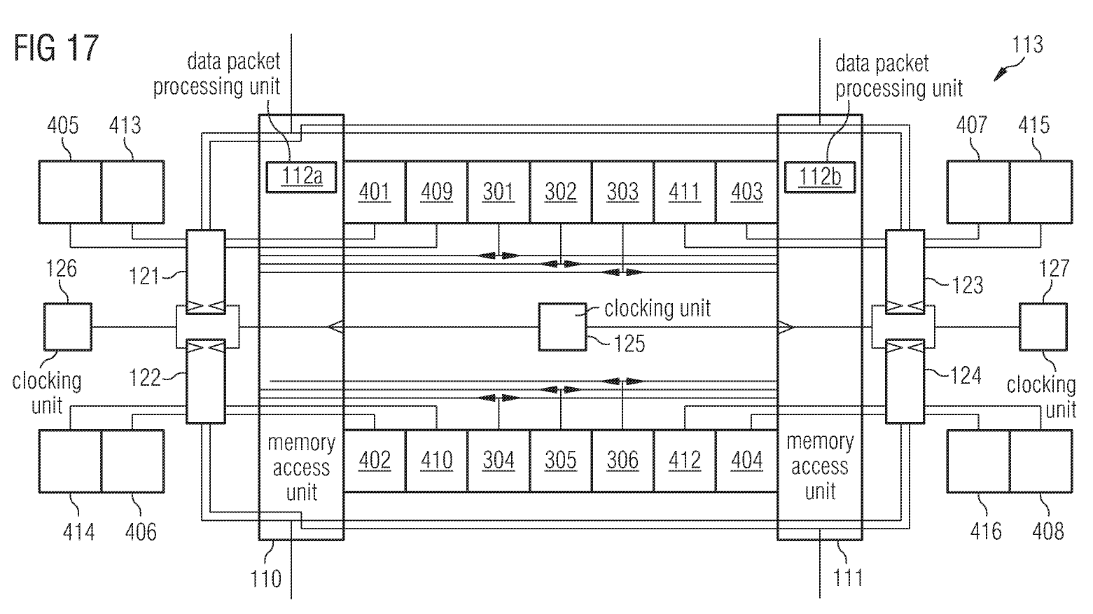

An embodiment of a memory arrangement containing a spine 113 is illustrated in FIGS. 16 and 17. This memory arrangement is adapted to be used in a data processing architecture as illustrated in FIG. 2c, wherein the eCA data packets are distributed by a fly-by bus 102 directly from the data processing unit 101 to each of the memory arrangements 100, 104, 105, and the DQ data packets are transmitted in a daisy chain arrangement via connections 108, 109 and 103 from the memory arrangements to the data processing unit 101.

FIG. 16 illustrates one embodiment of a spine 113 containing six eCA input ports 301-306 for receiving the eCA data packets, but no eCA output ports, as the eCA data packets do not have to be repeated in the data processing architecture illustrated in FIG. 2c. Furthermore, the spine 113 contains four DQ data input ports 401-404 for receiving DQ data packets to be repeated and four DQ output ports 405-408 for outputting repeated DQ data packets or outputting read data retrieved from the memory arrangement itself.

In this embodiment, processing of eCA data packets is therefore comparable to the processing of eCA data packets as described in conjunction with FIG. 10, and DQ data packet processing is comparable to the one described in conjunction with FIG. 8. As no repeating of eCA data packets is necessary in this embodiment, eCA data output ports 307-312 of FIG. 8 are not necessary in this embodiment.

As illustrated in FIG. 17, this embodiment further comprises four additional DQ data input ports 409-412 and four additional DQ data output ports 413-416. The DQ input ports are arranged beside the existing DQ input ports 401-404 between the memory access units 110 and 111 as illustrated in FIG. 16. The additional DQ output ports 413-416 are arranged beside the existing DQ output ports 405-408 as illustrated in FIG. 17.

FIG. 17 illustrates the use of the additional DQ input and output ports 409-416. The multiplexing FIFOs 121-124 either repeat received DQ data packets at the DQ input ports 401-404 and 409-412 to be repeated in a daisy chain application to the DQ output ports 405-408 and 413-416, respectively, or the multiplexing FIFOs 121-124 forward read data retrieved from the memory banks of the memory arrangement via the memory access units 110 and 111 in the form of DQ data packets formed by data packet processing units 112a and 112b to the DQ output ports 405-408 and 413-416.

Thus, the read data transmission speed is doubled in the memory arrangement embodiment containing the spine 113 illustrated in FIG. 17. Therefore, this embodiment with nearly the same number of input and output ports for receiving and transmitting eCA and DQ data packets as the embodiment of FIG. 7 achieves an increased DQ data transmission bandwidth and provides at the same time the possibility of connecting large amounts of memory to the data processing unit 101 by using the combined fly-by and daisy chain architecture of FIG. 2C.

As described above, the embodiments described above with reference to the figures may be realized each on a dedicated chip, or any combination of the embodiments described above may be realized on one chip which is configurable via a set-up procedure to realize any of the combined embodiments.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method of processing data in a memory arrangement, the method comprising:
receiving and transmitting the data at/from the memory arrangement in the form of data packets according to a predefined protocol;
distributing each received data packet to at least two separate data packet processing units, wherein each data packet processing unit is coupled to a portion of memory cells of the memory arrangement;
processing, at each data packet processing unit, parts of the received data packets that relate to the portion of the memory cells the data packet processing unit is coupled to; and
generating a data packet to be transmitted including setting up, with each data packet processing unit, a part of the data packet to be transmitted.

2. The method of claim 1, wherein the data packets comprise read, write, address and command data packets.

3. The method of claim 2, wherein the write, address and command data packets each comprise one of:
54 bits, the 54 bits being transferred via six ports of the memory arrangement, wherein per data packet each of the six ports transfers nine bits of the data packet serially; or
64 bits, the 64 bits being transferred via eight ports of the memory arrangement, wherein per data packet each of the eight ports transfers eight bits of the data packet serially.

4. The method of claim 2, wherein the read data packets are transferred via one of four ports or eight ports of the memory arrangement.

5. A method of processing data in a memory arrangement, the method comprising:
receiving and transmitting the data at/from the memory arrangement in the form of data packets according to a predefined protocol;
distributing the received data packets to at least two separate data packet processing units, wherein each data packet processing unit is coupled to a portion of memory cells of the memory arrangement;
processing, at each data packet processing unit, parts of the received data packets that relate to the portion of the memory cells the data packet processing unit is coupled to;
generating a data packet to be transmitted including setting up, with each data packet processing unit, a part of the data packet to be transmitted; and
forwarding a received data packet to another memory arrangement coupled to the memory arrangement, including setting up, with each data packet processing unit, a part of the data packet to be forwarded.

6. A memory arrangement comprising:
an interface configured to receive and transmit data in the form of data packets according to a predefined protocol; and
at least two separate data packet processing units, wherein each data packet processing unit is coupled to a portion of memory cells of the memory arrangement and to the interface, is configured to processes that part of the received data packet that relates to the portion of the memory cells the data packet processing unit is coupled to, and is configured to generate a part of a data packet to be transmitted.

7. The memory arrangement of claim 6, wherein the data packets comprise read, write, address and command data packets.

8. The memory arrangement of claim 6, comprising:
two receive clock units configured to generate a clock with which data packets are received, one for each data packet processing unit; and
two transmit clock units configured to generate a clock with which data packets are transmitted, one for each data packet processing unit.

9. The memory arrangement of claim 6, wherein the interface comprises at least three ports configured to receive and transmit data packets, wherein:
a first and a second data packet processing unit of the at least two data packet processing units are spaced apart with a first portion of the ports disposed in an area between the first and second data packet processing units;
a second portion of the ports is disposed in an area extending from the first data packet processing unit in a direction opposite to the second data packet processing unit; and
a third portion of the ports is disposed in an area extending from the second data packet processing unit in a direction opposite to the first data packet processing unit.

10. The memory arrangement of claim 6, wherein the interface comprises eight output ports for transmitting data packets, wherein four output ports of the eight output ports are coupled to one of the data packet processing units and the other four output ports of the eight output ports are coupled to another of the data packet processing units.

11. The memory arrangement of claim 6, wherein the interface comprises four output ports for transmitting data packets, wherein the four output ports are coupled to one of the data packet processing units only.

12. The memory arrangement of claim 6, wherein the interface comprises:
eight input ports receiving address, command, and write data packets, and
eight output ports outputting read data packets;
wherein a first and a second data packet processing unit of the at least two data packet processing units are spaced apart with four input ports of the input ports and four output ports of the output ports disposed in an area between the first and second data packet processing units;
wherein two input ports of the input ports and two output ports of the output ports are disposed in an area extending from the first data packet processing unit in a direction opposite to the second data packet processing unit; and
wherein two input ports of the input ports and two output ports of the output ports are disposed in an area extending from the second data packet processing unit in a direction opposite to the first data packet processing unit.

13. The memory arrangement of claim 6, wherein each data packet processing unit is configured to set up a part of a data packet to be forwarded to another memory arrangement.

14. The memory arrangement of claim 13, comprising;
a common receive clock unit configured to generate a clock with which data packets are received for the at least two data packet processing units; and
at least two transmit clock units configured to generate a clock with which data packets are transmitted, one for each data packet processing unit.

15. The memory arrangement of claim 13, wherein the interface comprises separate input ports and at least two output ports configured to receive and transmit data packets, respectively, wherein:
a first and a second data packet processing unit of the at least two data packet processing units is spaced apart with the input ports disposed in an area between the first and second data packet processing units;
a first portion of the output ports is disposed in an area extending from the first data packet processing unit in a direction opposite to the second data packet processing unit; and
a second portion of the output ports is disposed in an area extending from the second data packet processing unit in a direction opposite to the first data packet processing unit.

16. The memory arrangement of claim 13, wherein the interface comprises four output ports for transmitting read data packets, wherein two output ports of the four output ports are coupled to one of the data packet processing units and two output ports of the four output ports are coupled to another of the data packet processing units.

17. The memory arrangement of claim 13, wherein the interface comprises:
primary input ports configured to receive address, command, and write data packets;
secondary output ports configured to forward address, command, and write data packets,
secondary input ports configured to receive read data packets; and
primary output ports configured to transmit and forward read data packets;
wherein the data packet processing units are configured to process the address, command, and write data packets received at the primary input ports and to forward to the secondary output ports; and
wherein the data packet processing units are configured to forward the read data packets received at the secondary input ports along with read data packets generated by the data packet processing units to the primary output ports.

18. A computer system comprising:
a processing unit; and
at least two memory arrangements, each memory arrangement comprising:
an interface configured to receive and transmit the data in the form of data packets according to a predefined protocol, the data packets comprising read, write, address and command data packets, wherein the interface comprises:
primary input ports configured to receive address, command, and write data packets;
secondary input ports configured to receive read data packets; and
primary output ports configured to transmit and forward read data packets; and
at least two separate data packet processing units, wherein each data packet processing unit is coupled to a portion of memory cells of the memory arrangement and to the interface, is configured to process that part of a received data packet that relates to the portion of the memory cells the data packet processing unit is coupled to, and is configured to generate a part of a data packet to be transmitted.

19. The computer system of claim 18, wherein:
each data packet processing unit is configured set up a part of a data packet to be forwarded to another memory arrangement;
the interface comprises secondary output ports configured to forward address, command, and write data packets;
the data packet processing units are configured to process the address, command, and write data packets received at the primary input ports and to forward the address, command, and write data packets to the secondary output ports;
the data processing units are configured to forward the read data packets received at the secondary input ports along with read data packets generated by the data packet processing units to the primary output; and
a first and a second memory arrangement of the at least two memory arrangements are arranged such that the primary input ports of the first memory arrangement are coupled to address, command, and write data packet output ports of the processing unit, the secondary output ports of the first memory arrangement are coupled to the primary input ports of the second memory arrangement, the primary output ports of the first memory arrangement are coupled to the secondary input ports of the second memory arrangement, and the primary output ports of the second memory arrangement are coupled to read data input ports of the processing unit.

20. The computer system of claim 19, wherein the computer system further comprises:
at least one intermediate memory arrangement, the at least one intermediate memory arrangement arranged between the first memory arrangement and the second memory arrangement such that the first memory arrangement, the at least one intermediate memory arrangement and the second memory arrangement form a daisy chain,
wherein one of the at least one intermediate memory arrangement is coupled to a preceding memory arrangement in the daisy chain and a succeeding memory arrangement in the daisy chain such that the primary input ports of the one intermediate memory arrangement are coupled to the secondary output ports of the preceding memory arrangement, the secondary output ports of the one intermediate memory arrangement are coupled to the primary input ports of the succeeding memory arrangement, the secondary input ports of the one intermediate memory arrangement are coupled to the primary output ports of the preceding memory arrangement, and the primary output ports of the one intermediate memory arrangement are coupled to the secondary input ports of the succeeding memory arrangement.

21. The computer system of claim 18, wherein:
the data packet processing units are configured to process the address, command, and write data packets received at the primary input ports, and to forward the read data packets received at the secondary input ports along with read data packets generated by the data packet processing units to the output ports; and
a first and a second memory arrangement of the at least two memory arrangements are arranged such that the primary input ports of the first and the second memory arrangements are coupled to address, command, and write data packet output ports of the processing unit, the output ports of the first memory arrangement are coupled to the secondary input ports of the last memory arrangement, and the output ports of the second memory arrangement are coupled to read data input ports of the processing unit.

22. The computer system of claim 21, wherein the computer system further comprises:
at least one intermediate memory arrangement, the at least one intermediate memory arrangement being arranged between the first memory arrangement and the second memory arrangement such that the first memory arrangement, the at least one intermediate memory arrangement and the second memory arrangement form a daisy chain,
wherein one of the at least one intermediate memory arrangement is coupled to a preceding memory arrangement in the daisy chain and a succeeding memory arrangement in the daisy chain such that the primary input ports of the one intermediate memory arrangement are coupled to address, command, and write data packet output ports of the processing unit, the secondary input ports of the one intermediate memory arrangement are coupled to the output ports of the preceding memory arrangement, and the output ports of the one intermediate memory arrangement are coupled to the secondary input ports of the succeeding memory arrangement.

23. A memory chip, comprising:
a memory arrangement configured to receive, process, and transmit data in the form of data packets according to a predefined protocol, the memory arrangement comprising:
an interface configured to receive and transmit the data in the form of data packets;
at least two separate data packet processing units, wherein each data packet processing unit is coupled to a portion of memory cells of the memory arrangement and to the interface, is configured to process that part of a received data packet that relates to the portion of the memory cells the data packet processing unit is coupled to, and is configured to generate a part of a data packet to be transmitted.

24. The memory chip of claim 23, wherein each data packet processing unit is configured to set up a part of a data packet to be forwarded to another memory arrangement.

25. The memory chip of claim 23, wherein the memory arrangement is configurable during initialization of the memory chip to have an initial configuration where each data packet processing unit is configured to set up a part of a data packet to be forwarded to another memory arrangement or to have an initial configuration where each data packet processing unit is not configured to set up a part of a data packet to be forwarded to another memory arrangement.
